(19) United States
(12) Patent Application Publication
(10) Pub. No.: US 2014/0232724 A1
(43) Pub. Date: Aug. 21, 2014

(54) MOVING VISUALIZATIONS BETWEEN DISPLAYS AND CONTEXTS

(71) Applicant: SCHLUMBERGER TECHNOLOGY CORPORATION, Sugar Land, TX (US)

(72) Inventors: Vivek Jain, Beijing (CN); Chongwei Wan, Beijing (CN)

(73) Assignee: SCHLUMBERGER TECHNOLOGY CORPORATION, Sugar Land, TX (US)

(21) Appl. No.: 14/181,803

(22) Filed: Feb. 17, 2014

Related U.S. Application Data
(60) Provisional application No. 61/766,276, filed on Feb. 19, 2013.
(60) Provisional application No. 61/766,280, filed on Feb. 19, 2013.

(51) Int. Cl. G06T 11/20

(52) U.S. Cl. CPC G06T 11/206
USPC 345/440

(57) ABSTRACT

Apparatus for and methods including displaying a visualization of an object within a boundary area of a first display based on first display characteristics, determining second display characteristics of a second display, and formatting the visualization based on the second display characteristics. The visualization is then provided to the second display, without at least a portion of the boundary area, for display on the second display.

### CROSS-REFERENCE TO RELATED APPLICATIONS

This application claims the benefit of U.S. Provisional Application No. 61/766,276, entitled “Interactive Data Selection for Visualization in a Geoscience System,” filed Feb. 19, 2013, the entire disclosure of which is hereby incorporated herein by reference. This application also claims the benefit of U.S. Provisional Application No. 61/766,280, entitled “Configurable Extended Window Layout for a Geoscience System,” filed Feb. 19, 2013, the entire disclosure of which is hereby incorporated herein by reference.

### BACKGROUND OF THE DISCLOSURE

A geoscience software application may aggregate reservoir data from multiple data sources. The application may have a work area in memory for data management and visualization. The work area may be a portal on a window or other display area that a user employs to access data stored in memory of a local or remote computer. The user may visualize the data through a two-dimensional (2D) or three-dimensional (3D) visualization. The visualization may be a visual image, such as a 3D contour map or a histogram. The work area can have multiple user interfaces by which multiple users may interact with the data, manipulate or otherwise alter the visualization of an object, and perform operations on the data. The data can be represented in various types of display areas, and can be laid out inside a boundary area of a display. The work area may be the primary focus of users, who may work with many display areas at once, such as to monitor and analyze data simultaneously in different views (e.g., in a 3D view, a histogram view, or a cross-sectional view). Users may also switch between different sets of display areas, visualizations, and/or visualization layouts, and may utilize multiple displays for a greater viewing area.

Accessing the data for visualization or analysis may be initiated from an input tree of data organized as folders and files, and may entail an extended series of mouse or keyboard clicks for access to a particular data entry. The input tree may be a data structure organized as files stored in a hierarchy of folders, which may be stored in folders at a still higher level. To access such input tree data, users may first be directed to the root of the hierarchy and then down through the folders to obtain a file disposed at a lower level. Users may select a file to visualize data therein or perform analysis via additional keyboard entries or mouse clicks to access the lower level file.

### SUMMARY OF THE DISCLOSURE

The present disclosure introduces a method in which a visualization of an object is displayed within a boundary area of a first display based on first display characteristics. Second display characteristics of a second display may then be determined. The visualization may then be formatted based on the second display characteristics. The visualization may then be provided to the second display, without at least a portion of the boundary area, for display on the second display.

The present disclosure also introduces an apparatus that includes a processor and memory including computer program code. The processor, the memory, and the computer program code are collectively operable to cause the apparatus to display a visualization of an object within a boundary area of a first display based on first display characteristics. The processor, the memory, and the computer program code are further collectively operable to determine second display characteristics of a second display, format the visualization based on the second display characteristics, and provide the visualization to the second display, without at least a portion of the boundary area, for display on the second display.

The present disclosure also introduces a computer program product comprising a program code stored in a tangible form in a computer readable medium. The computer program product and program code are operable to cause an apparatus comprising a processor and a memory to display a visualization of an object within a boundary area of a first display based on first display characteristics. The apparatus may then determine second display characteristics of a second display, format the visualization based on the second display characteristics, and provide the visualization to the second display without at least a portion of the boundary area.

Additional aspects of the present disclosure are set forth in the description that follows, and/or may be learned by a person having ordinary skill in the art by reading the materials herein and/or practicing the principles described herein. At least some aspects of the present disclosure may be achieved via means recited in the attached claims.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a display representation of object visualizations according to one or more aspects of the present disclosure.

FIG. 2 is a display representation of object visualizations according to one or more aspects of the present disclosure.

FIG. 3 is a flow-chart diagram of at least a portion of a method according to one or more aspects of the present disclosure.

FIG. 4 is a display representation of object visualizations according to one or more aspects of the present disclosure.

FIG. 5 is a display representation of object visualizations according to one or more aspects of the present disclosure.

FIG. 6 is a display representation of object visualizations according to one or more aspects of the present disclosure.

FIG. 7 is a display representation of object visualizations according to one or more aspects of the present disclosure.

FIG. 8 is a block diagram of at least a portion of apparatus according to one or more aspects of the present disclosure.

FIGS. 9A and 9B are collectively a flow-chart diagram of at least a portion of a method according to one or more aspects of the present disclosure.

FIG. 10 is a block diagram of at least a portion of apparatus according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

Apparatus and methods according to one or more aspects of the present disclosure may be described herein with respect to example embodiments in a specific context, namely, applications that support technical analysis in an analytic system, such as a geoscience system, and management of visualizations and visualizations layout within a display area. While one or more aspects of the present disclosure may be described in the environment of a geoscience system, however, technical analytic applications that may benefit from an application that supports technical analysis as described herein is also within the scope of the present disclosure. Other technical analytic applications may include, without limitation, astronomical, cellular telephone, biological, traffic management, and intelligence-gathering analytic systems, among others.

The present disclosure introduces systems and methods for interactively moving data of an object for visualization, analysis, and management in a geoscience system or other technical analytic application. In an example implementation, a system may allow a user to select a visualization from an originating screen/display in the system and move it to another, receiving screen/display of the system. The receiving screen/display (e.g., another screen in a computer processor system running a geoscience application) may apply a context to the data that may be different from the context in the originating screen/display, and may transform the data accordingly to provide a particular visible functionality on the receiving screen/display.

To display a visualization of data stored in a work area of a geoscience system, data behind an oil or gas well and/or other object of interest may be formatted in a selected context, such as in a 2D or 3D contour map, a histogram graph, a log or map of well parameters (e.g., temperature, pressure, depth, etc.), and/or other contexts. Data associated with an object of interest, such as a well parameter or feature, may be stored in system memory. Moving and transforming data employed to form a contour map in the context of a 3D window to a context of a 2D window, for example, may be performed by transforming data that has already been presented to the user and/or acquiring further data from memory.

To present a user with a visualization of data of an object in a new context, such as visualization of a 3D contour map as a histogram (among myriad other examples within the scope of the present disclosure), the system may first recognize the new context in which the data is to be visualized. For example, if the data employed to construct a contour map includes a pressure distribution, a transformation to a histogram of pressures may be entail selecting and operating on the pressure distribution data. Data for the distribution of pressure may also or instead be inferred from an underground well map that includes depth data, perhaps utilizing density and depth data associated with the material displayed in the map. Thus, for example, the system may recognize that the data is to be transformed and presented as a histogram, and may subsequently acquire and transform the data automatically. The system may also recognize from past user activities, for example, that a histogram may present temperatures and/or pressures in a particular manner or with a particular scale (e.g., a Celsius or Fahrenheit scale). The system may also include an option for the user to select a particular form and/or scale for the histogram.

The data utilized to construct a visualization of a histogram may already be associated with the data that was utilized to construct the original visualization. However, the data utilized to construct the new visualization may also or instead be obtained by analysis of one or more properties of the data in the original visualization. Thus, memory in the work area may retain more data than is displayed in the original visualization. Moreover, in the new visualization, some of the data that was displayed in the original visualization may be suppressed, and further data retained in memory may be acquired and displayed in the new visualization. The system may fetch and obtain missing data to produce the new visualization, such as a histogram from public or private data sources such as the Internet, or from other data sources within the system, such as a file stored elsewhere in the data tree of the work area.

Thus, the system may display a visualization of data of an object according to a context of a display area, such as the context of a 3D map, a histogram, and/or others. The context of a display may refer to a type of visualization, such as a contour map or a histogram, and also to visualization parameters, such as display settings, attributes, properties, designer preferences, palette windows, cross plots, spider plots, pivots, and tables, among others.

A system according to one or more aspects of the present disclosure may allow a user to move data seamlessly from one display area to another in a single operation, such as a single mouse click, keyboard shortcut, or “drag-and-drop” operation. Such operations may be intuitive for a user, and may give greater screen real estate to the displays for the user to perform operations, which may improve efficiency and/or reduce the number of mouse movements. In some implementations, this may reduce user stress, and may benefit the user's health and productivity.

One or more aspects of the present disclosure may also allow an option for adding real estate for visualization of an object on a display. For example, visual material in a boundary area that is not utilized for a task, such as icons and toolbars provided on a desktop, may be removed from a display. A further option introduced herein entails shrinking a portion of a display area to produce a clear display area. This option may allow a context to be assigned to the newly created clear display area, and for a new visualization to be created in the newly created clear display area with the assigned context.

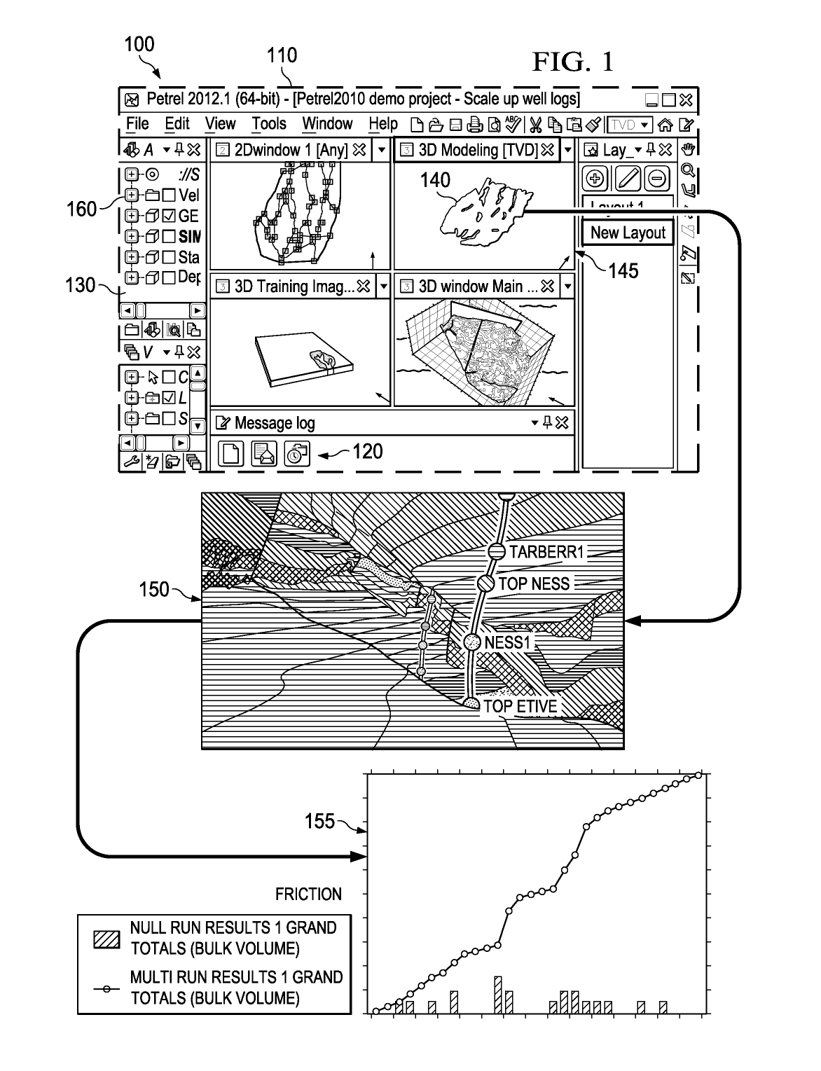

FIG. 1 is a display representation of an implementation of a plurality of visualizations of an object produced in accordance with a display 100 according to one or more aspects of the present disclosure. The display 100 includes a plurality of display areas bounded by a boundary area generally designated by reference numeral 110. The boundary area 110 includes conventional toolbars, etc., icons such as icon 120 (e.g., an instant messaging client icon), and a work area generally designated by reference numeral 130. The display 100 also includes a plurality of visualizations of an object (e.g., a well or a portion thereof) in respective display areas such as a first visualization 140 of the object with a first visualization context in a first display area 145. The multiple visualizations are arranged in a first visualization layout as designated by “Layout 1” in the boundary area 110. For purpose of illustration, an exploded view of a second visualization 150 of the object with a second visualization context (e.g., a contour map) is illustrated beyond the boundary area 110. Also, an exploded view of a third visualization 155 of the object with a third visualization context (e.g., a histogram graph) is illustrated beyond the boundary area 110.

The visualizations of the object may be transformed into different visualization contexts by selecting a visualization (in a visualization context) in response to a stimulus, such as by dragging the visualization to a context icon in the boundary area 110, to elsewhere on the display 100, or to another display area. The system then transforms data for the object for another visualization context associated with the other display area. The system also reforms the visualization to conform to the other visualization context to construct another visualization of the object for display in the other display area. For example, the second visualization 150 of the well in the contour map context may be reformed into a third visualization 155 of the well in the histogram graph context. While the first, second, and third visualizations 140, 150, and 155, respectively, are positioned in different display areas, the display areas are not limited to a single display such as display 100. Also, different display areas of one or more displays may be assigned different contexts, such that a visualization may be selected and moved into a display area to view the object in the visualization context of choice. Also, data for an object may be modified in, for example, an input tree 160 in the work area 130, such as to obtain updated visualizations in the respective display areas. For example, the data may be edited, added to, and/or deleted, and the results may be observed in real time.

As mentioned above, the system may allow a user to view an object in many display contexts, such as in the context of a histogram graph visualization. To perform this task, a visualization, such as with the 3D contour map context, may be selected using a mouse, keyboard, and/or other input device, and subsequently moved to a histogram graph display area and/or on a histogram graph icon. However, a command may also or instead be issued to send the visualization of the object for histogram analysis directly from the visualization with the 3D contour map context. The data of the object may then be interpreted and transformed into a histogram graph context for view in the histogram graph display area. The visualization of the object may be moved from one display to each of a group of displays, such that the object may be displayed in each of the displays with a single operation.

The visualization context may be modified by dragging the visualization a relatively short distance in the direction of the display area for another visualization context. In a sense, the user “shoots” the visualization of the object to the display area for another visualization context. It should be understood that different display areas may be located on the same display or different displays (e.g., remote displays), and the displays may be identified by an instant messaging and/or other type of client. The receiving display may be selected by clicking an icon for an entry in the instant messaging client.

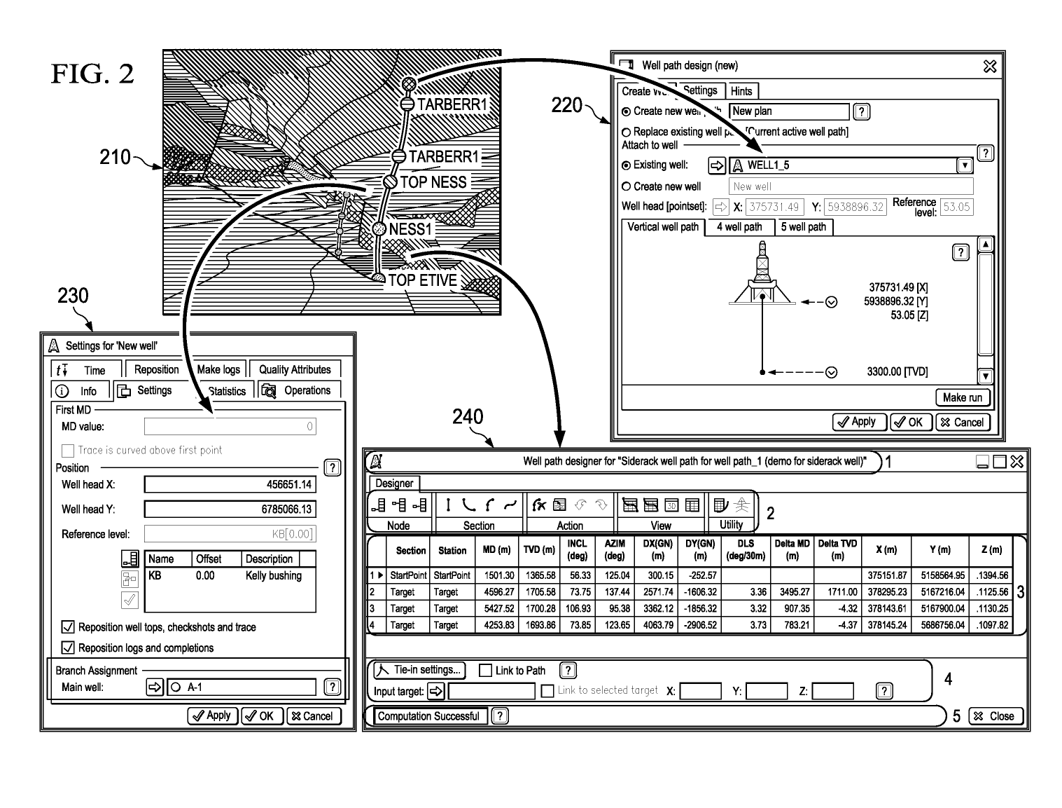

FIG. 2 is a display representation of an implementation of multiple visualizations of an object according to one or more aspects of the present disclosure. A first visualization of the object (e.g., a well) with a 3D contour map context is illustrated in a first display area 210. A second visualization of the well with a vertical well path context (in accordance with a well path design) is illustrated in a second display area 220. A third visualization of the well with a settings context is illustrated in a third display area 230. A fourth visualization of the well with a sidetrack well path context (in accordance with a well path design) is illustrated in a fourth display area 240.

Taking the vertical well path context as an example, the first visualization of the 3D contour map context may be selected utilizing a mouse, keyboard, and/or other input device, and subsequently moved to the second display area 220 or onto a vertical well path context icon (see, e.g., FIG. 1). In another implementation, a command may be issued to send the first visualization of the well for the vertical well path analysis directly from the first visualization with the 3D contour map context. The data of the object may then be interpreted and transformed into a vertical well path context for view in the second display area 220.

Thus, a system within the scope of the present disclosure may allow reduced human-system interaction, which may improve operational efficiency for a user to perform an analytic task. Tasks and actions may also be made intuitive and perhaps simpler by utilizing natural human actions and/or reactions. Effort expended by a user to switch contexts between visualizations and to manage data may also be reduced.

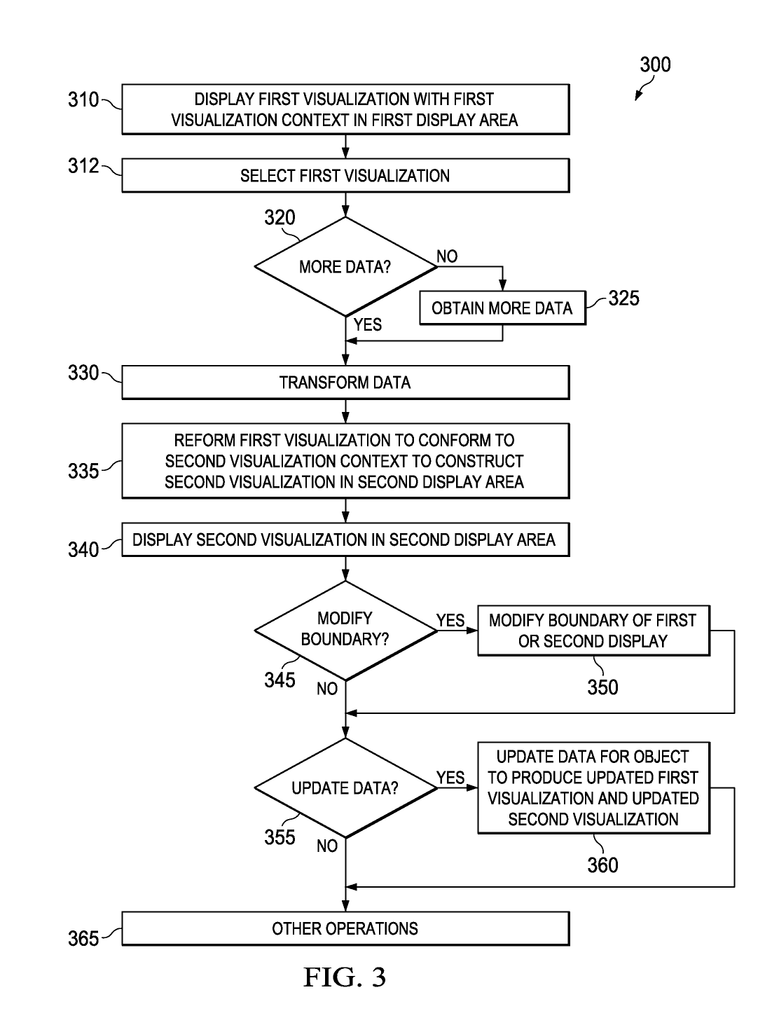

FIG. 3 is a flow-chart diagram of at least a portion of a method (300) according to one or more aspects of the present disclosure. The method (300) may include displaying (310) a first visualization of an object with a first visualization context in a first display area, such as on a first display. The first visualization may be selected (315) in response to a stimulus, such as by moving the first visualization to a second display area, perhaps on a second display, or by moving the first visualization to an icon associated with a second visualization context. The second display may be identified with an instant messaging client and/or other client associated with the first display. If the system is associated with a geoscience system, the object may be a well, and the first visualization context and the second visualization context may be, without limitation, a 2D or 3D contour map of the well, a histogram graph of the well, a temperature map of the well, and/or a pressure map of the well.

The method (300) may then include determining (320) if creating the second visualization of the object with the second visualization context calls for additional data. If more data is called for, additional data may be obtained (325) to create the second visualization of the object. Obtaining (325) the data may include fetching data from an input tree and/or fetching data from a public data source to construct the second visualization of the object.

If sufficient data is determined (320) to be available, data for the object is transformed (330) for a second visualization context associated with the second display area. The first visualization may be reformed (335) to conform to the second visualization context to construct the second visualization of the object for display in the second display area. The second visualization may then be displayed (340) in the second display area. The method (300) may then include determining (345) if modification of a boundary area associated with the first and/or second display is called for, such as to increase the display area. If such modification is called for, then the boundary area may be modified (350) by, for example, removing a toolbar of the first and/or the second display.

The method (300) may then include determining (355) if data for the object is to be updated. If the data for the object is to be updated, the data is updated (360) in accordance with an input tree, for example, such as to produce an updated first visualization and an updated second visualization. Various additional operations may then be performed (365).

One or more aspects of the present disclosure may entail a configurable screen layout management process that may provide and/or manage visualizations of an object on multiple screens/displays of multiple devices for a geoscience and/or other analytic system. As described above, a geoscience system may have at least one work area for data management. One or more aspects of the present disclosure may apply to these software-based geoscience and/or other analytic systems.

An object with the underlying data in such a geoscience and/or other analytic system may be represented in various types of visualizations, and may be laid out inside a display area on a display. As described above, the work area in a geoscience system (and other analytic systems) may be a data repository in memory where users operate, and users may work with multiple visualizations in two or more displays or display areas at the same time, such as to monitor and/or analyze data in different views and contexts (e.g., in a 3D visualization, a 2D map visualization, and a cross-sectional visualization, among other examples). The users may switch between different sets of visualizations and/or different layouts to perform their work, and may work with the visualizations on multiple screens to allow a greater viewing area. While such operations may entail environmentally dependent setup of the multiple displays, one or more aspects of the present disclosure may substantially reduce or remove a limitation of the display area in an analytic system, such that users may configure a layout of visualizations for visibility on multiple displays or display areas. Users may also utilize a layout of the visualizations allowing information to be sent to different displays, including different types of displays and/or devices.

One or more aspects of the present disclosure may improve the efficiency of system interaction, such as through configurable, extended display layout management. Consequently, a user may not be constrained by a limited display inside the system, and may customize the visible work space in different ways. To achieve this, the system may allow a user to move a visualization or a group of visualizations between different displays without, for example, breaking the layout of the visualizations, and also to be able to save the layout of the visualization for the different displays and the display settings.

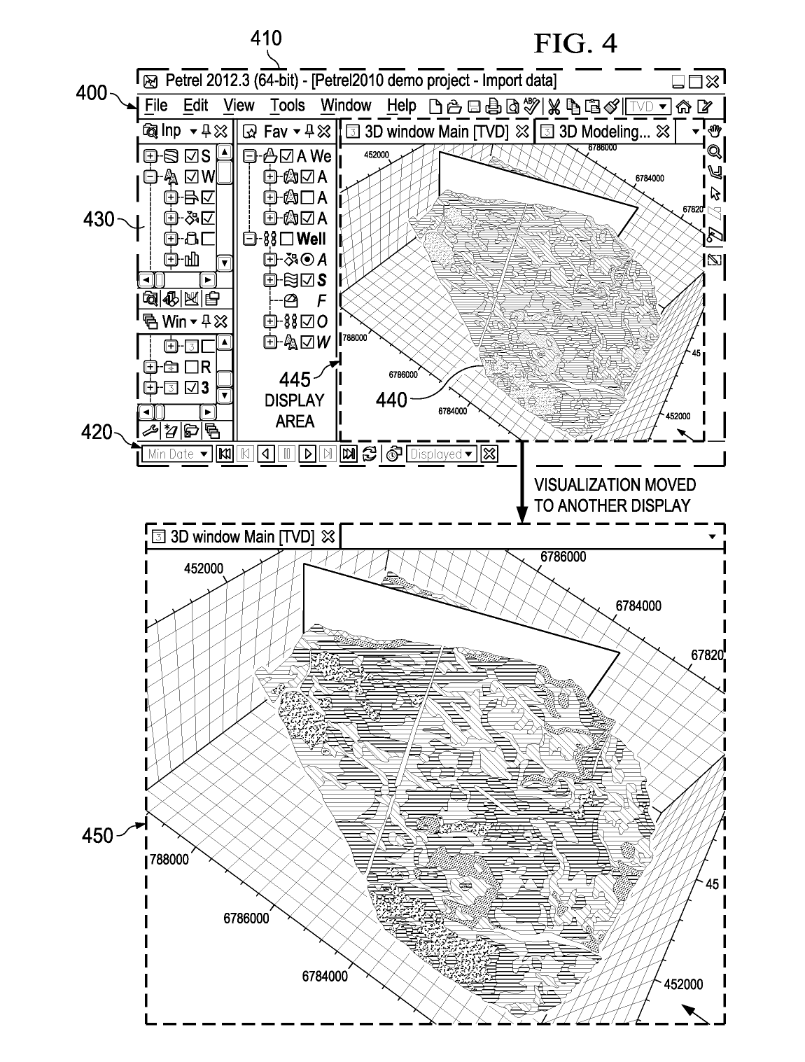

FIG. 4 is a display representation of an implementation of a visualization of an object produced in accordance with a first display 400 according to one or more aspects of the present disclosure. The first display 400 includes a plurality of display areas bounded by a boundary area, generally designated by the reference numeral 410. The boundary area 410 includes conventional toolbars, icons, etc., such as icon an instant messaging client icon 420, and a work area generally designated by the reference numeral 430. The first display 400 also includes a visualization 440 of an object (e.g., a well or a portion thereof) in a display area 445.

As illustrated in FIG. 4, the visualization 440 may be dragged or otherwise moved to a second display 450 without at least a part of (and in this case the entire) the boundary area 410 of the first display 400. While the boundary area 410 of the first display 400 may be imposed by an operating system of the associated electronic device (e.g., computer), one or more aspects of the present disclosure may allow moving and sharing of the visualization 440 without sharing the entire viewing area (e.g., peripheral elements and/or views) of the first display 400. The second display 450 may be, for example, a local projector or a remotely located display associated with another electronic device (e.g., computer) having an operating system.

Thus, a visualization or group of visualizations may be moved freely without breaking their layout, for example, so that a user is not forced to manually move the visualizations one-by-one and/or redo the layout, and is not limited by the space of a display area. The actual display area may be extended to the entire display area of one or more other displays, and different visualizations may be placed on different screens. The visualizations may also be selectively dragged out of a display area and placed in another display area wherever the user chooses. Additionally, different visualizations may be moved to different displays.

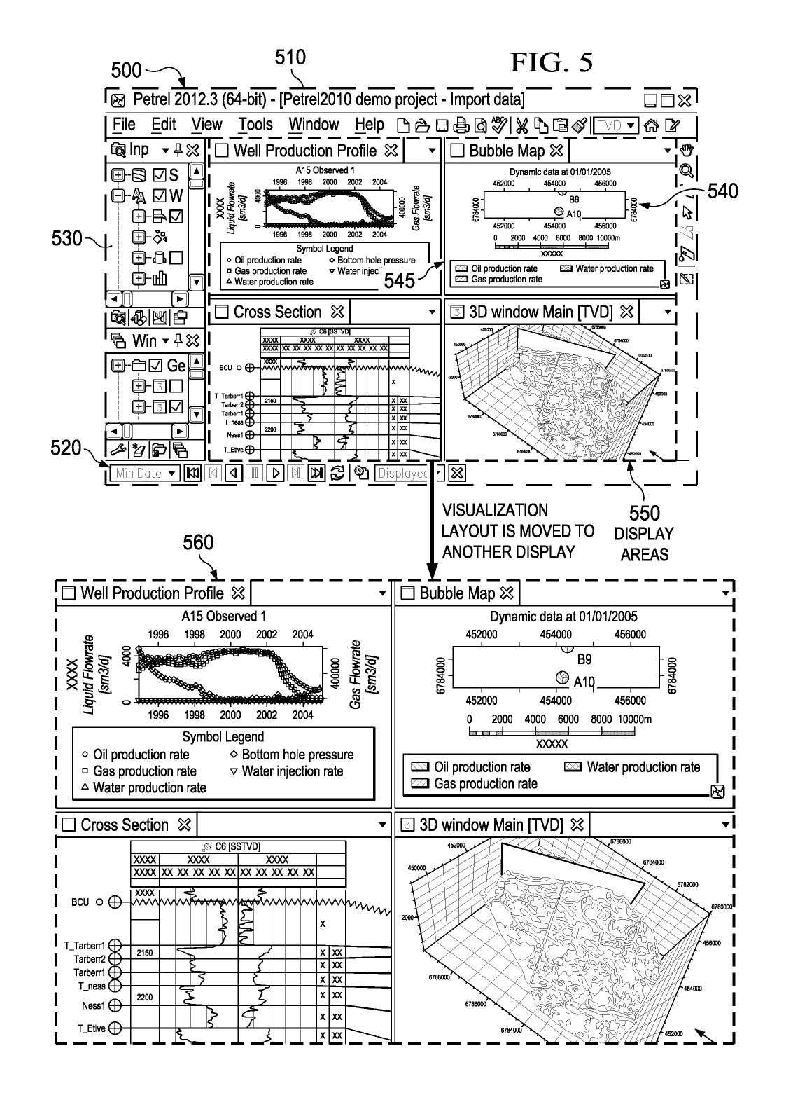

FIG. 5 is a display representation of an implementation of a plurality of visualizations of an object produced in accordance with a first display 500 according to one or more aspects of the present disclosure. The first display 500 includes a plurality of display areas bounded by a boundary area generally designated by the reference numeral 510. The boundary area 510 includes conventional toolbars, icons, etc., such as an instant messaging client icon 520, and a work area generally designated by the reference numeral 530. The first display 500 also includes a plurality of visualizations of a portion of a well or other object in respective display areas, such as a first visualization 540 of the object with a first visualization context in a first display area 545. The plurality of visualizations are arranged in a visualization layout 550.

As illustrated in FIG. 5, the visualization layout 550 (including the plurality of visualizations with respective visualizations contexts) may be dragged or otherwise moved to a second display 560 without at least a part of (and in this case the entire) the boundary area 510 of the first display 500. While the boundary area 510 of the first display 500 may be imposed by an operating system of the associated electronic device (e.g., computer), one or more aspects of the present disclosure may allow moving and sharing the visualization layout 550 without sharing the entire viewing area (e.g., peripheral elements and/or views) of the first display 500 and, in this case, without breaking the visualization layout 550. That is, the plurality of visualizations in the visualization layout 550 may be presented is the same configuration (relative layout and positions among the visualizations) on the first and second displays 500 and 560, respectively. The second display 560 may be, for example, a local projector or a remotely located display associated with another electronic device (e.g., computer) having an operating system.

Thus, one or more aspects of the present disclosure may allow free placement of one or more visualizations and/or visualization layouts without breaking the layout thereof. Consequently, the visualization layout 550 in the first display 500 may be automatically moved to the second display 560. The user may also save a visualization layout for different display settings and devices, and the system may automatically select the appropriate visualization layout based on a selected device/display. User may thus save a visualization layout in different configurations.

A particular visualization layout may be managed programmatically to allow for dynamic workflow-based customization. For example, if a user is using the first display 500 in a work mode and a second display 560 is available in a presentation mode, the user may preset and save different visualization layouts for these two modes on the first and second displays 500 and 560, respectively. The user may not be forced to reset the visualization layout each time the user switches mode. The system may automatically recognize the device/display combination, and may automatically switch the configuration to one that has been defined for that device/display and/or has been optimized by a system optimization. This may provide flexibility for the user to configure a display for a work environment or for a presentation environment. A user may also manage configurations of the visualizations, and can switch among them with ease. A group of visualizations may thus be moved without breaking the layout, so that the user is not forced to manually move visualizations one-by-one and/or redo a visualization layout thereof.

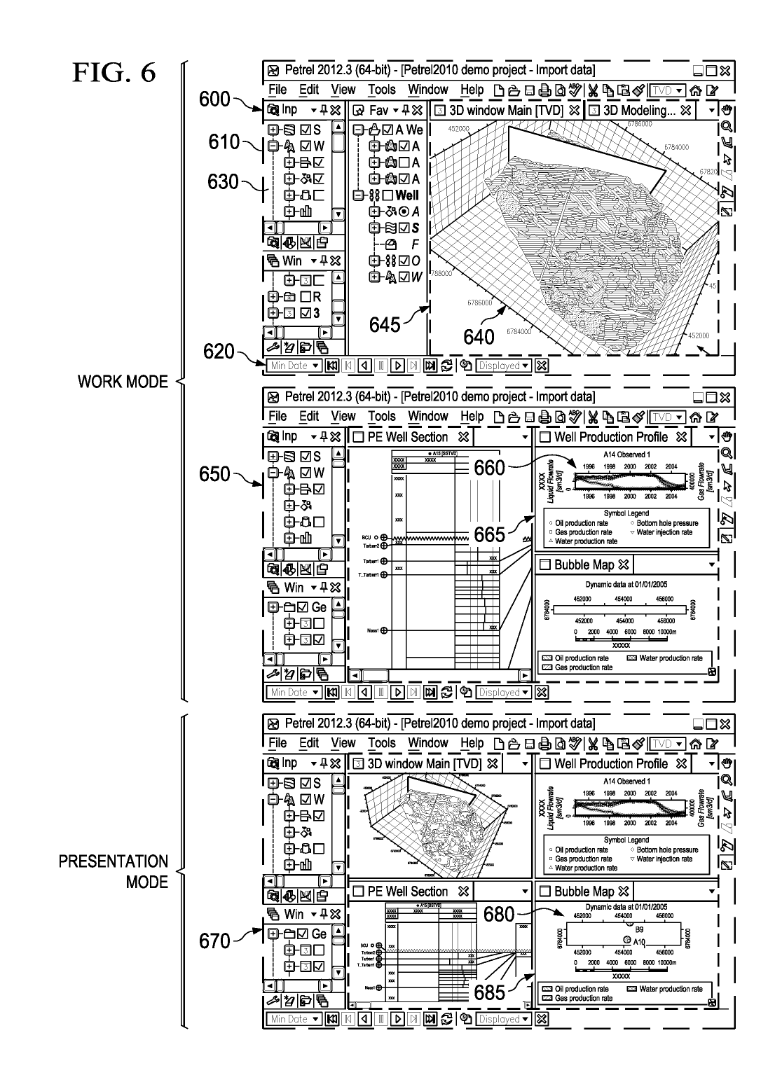

FIG. 6 is a display representation of an implementation of a plurality of visualizations of an object produced in accordance with a first display 600 according to one or more aspects of the present disclosure. The first display 600 includes a plurality of display areas bounded by a boundary area generally designated by the reference numeral 610. The boundary area 610 includes conventional toolbars and icons, etc., such as an instant messaging client icon 620, and a work area generally designated by the reference numeral 630. The first display 600 also includes a visualization 640 of an object (e.g., a well or a portion thereof) with a first visualization context in a display area 645. The first display 600 may be operable in a work mode.

As illustrated in FIG. 6, the visualization 640 with a first visualization context is dragged or otherwise moved to a second display 650 without at least a part of (and in this case the entire) the boundary area 610 of the first display 600. While the boundary area 610 of the first display 600 may be imposed by an operating system of the associated electronic device (e.g., computer), one or more aspects of the present disclosure may allow moving and sharing of the visualization 640 without sharing the entire viewing area (e.g., peripheral elements and/or views) of the first display 600. The second display 650 may be operable in a work mode.

As described with respect to FIGS. 1 and 2, however, the visualization 640 of the object may be transformed into different visualization contexts by selecting the visualization 640 (in the first visualization context) in response to a stimulus, such as dragging the visualization 640 to the second display 650. The system may then transform data for the object for other visualization contexts associated with the second display 650. The system may also reform the visualization 640 to conform to the other visualization contexts to construct other visualizations (one of which is designated 660) of the object for display in the respective display areas (one of which is designated 665) on the second display 650. Thus, in the work mode, the second display 650 may display other visualizations of the object in a visualization layout with the respective visualizations contexts in the respective display areas.

As also illustrated in FIG. 6, the visualization 640 with a first visualization context may be dragged or otherwise moved to a third display 670 without at least a part of the boundary area 610 of the first display 600. While the boundary area 610 of the first display 600 may be imposed by an operating system of the associated electronic device (e.g., computer), one or more aspects of the present disclosure may allow moving and sharing of the visualization 640 without sharing the entire viewing area (e.g., peripheral elements and/or views) of the first display 600. The third display 670 may be operable in a presentation mode.

As described above, the visualization 640 of the object may be transformed into different visualization contexts by selecting the visualization 640 (in the first visualization context) in response to a stimulus such as dragging the visualization 640 to the third display 670. The system may then transform data for the object for other visualization contexts associated with the third display 670. The system may also reform the visualization 640 to conform to the other visualization contexts to construct other visualizations (one of which is designated 680) of the object for display in the respective display areas (one of which is designated 685) on the third display 670. Thus, in the presentation mode, the third display 670 may display other visualizations of the object in another visualization layout with the respective visualizations contexts in the respective display areas. For purposes of illustration, the third display 670 includes the visualization 640 of the object in the first visualization context from the first display 600 and the other visualizations of the object with the respective visualizations contexts from the second display 650. An analogous operation may be performed by dragging the visualizations in a visualization layout of the object with the respective visualizations contexts from the second display 650 to the third display 670.

The work mode may be employed by a user to analyze and edit data, whereas the presentation mode may be utilized to display a visualization on, for example, a projector or another user's screen. A user may save a visualization layout for different display and devices, and the system may automatically select the appropriate layout based on the device/display. The user may thus save a visualization layout in different configurations. Further, the configurations may be managed programmatically, such as for dynamic workflow-based customization. For example, if in work mode a user is using two displays, and in presentation mode just one display is available, then the user may preset and save different visualization layouts for the two modes, and is not forced to reset the layout each time when the user switches to a different mode.

As an example, a number of visualizations that may be presented to a client (“non-user”) or an audience may be larger or smaller than the number that a user is editing or is otherwise composing on a personal display. In a further example, different visualizations may be selected according to contexts, and may be shown on different displays. Thus, a user may limit what visualizations are displayed to a client, a colleague, an audience, or other non-users.

In addition to the visualization displays, other visualization parameters such as settings, designers, etc., may be saved in the layout of visualizations to allow the user to visualize data and modify/design data at the same time. Visualization parameters such settings, designer, and/or others in the system may also be saved in the visualization layout.

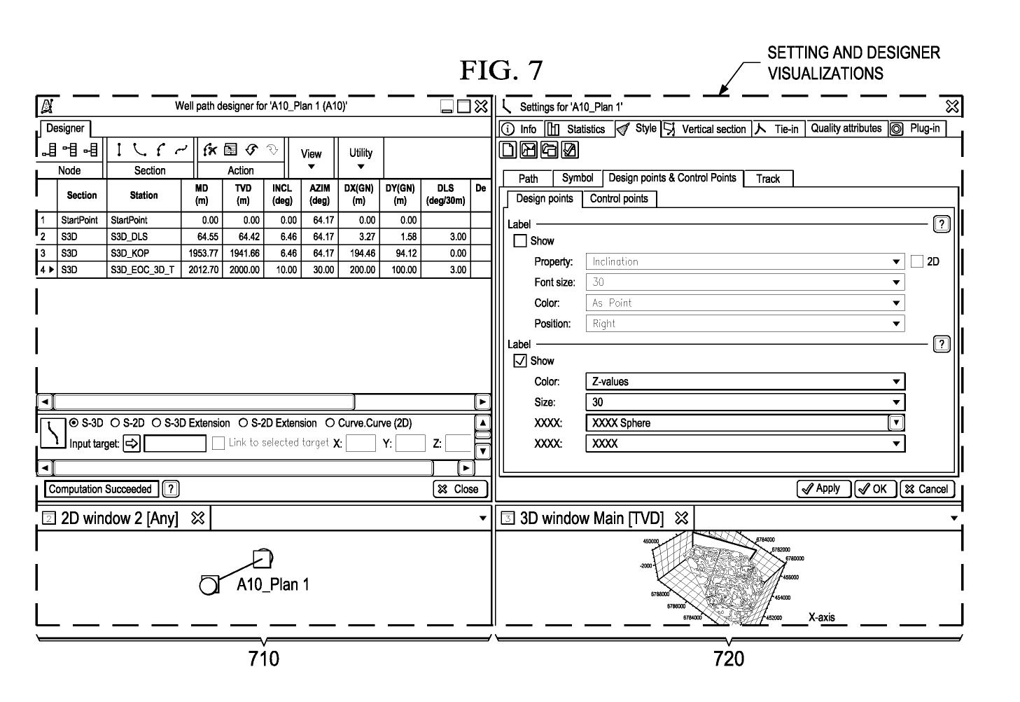

FIG. 7 is a display representation of an implementation of a plurality of visualizations of an object according to one or more aspects of the present disclosure. A first visualization 710 illustrates a visualization of settings that represent, for example, a contour map and/or a histogram graph context. A second visualization 720 illustrates a designer visualization that allows a user to edit or otherwise manipulate data in an input tree. Visualizations with contour map and histograms graph contexts may be displayed in conjunction with a visualization that allows the user to simultaneously edit data in the input tree. The system may allow a user to reflect a visualization within display areas and/or displays and define how the display will appear thereon. If a particular visualization or visualization layout is not defined, the system may automatically choose the same for the device/display.

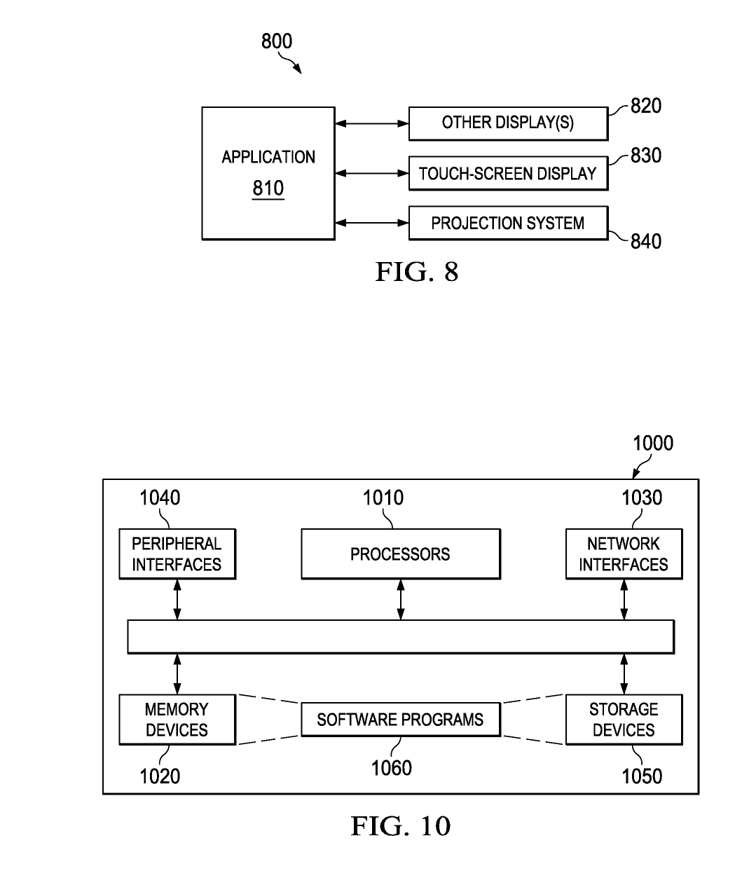

FIG. 8 is a block diagram an implementation of a system 800 for displaying visualization reflections according to one or more aspects of the present disclosure. Data related to operating a main application 810 of a geoscience and/or other analytic system may be displayed on one or more screens. Different visualizations may be sent to different types of devices for display. For example, visualizations may be sent to one or more other displays 820, a touch-screen display 830 (e.g., of a smart phone, tablet, etc.), and/or a projection system 840. The arrows in FIG. 8 are depicted as bidirectional to illustrate that the visualizations may be operative on, and/or produced with, data associated with an object within the main application 810.

Thus, an analytic system may be enhanced to augment display real estate for visualization of an object. A user may thus make use of an entire area of a display by extending the display area(s) of the display(s). Effort expended by a user to manage visualizations in a limited display area may be reduced. Efficiency may be improved, such as by making it easier to configure a visualization layout in multiple displays. Preset visualization layouts may be composed in different display settings, which may reduce the manual work of duplicating visualizations when switching between different settings.

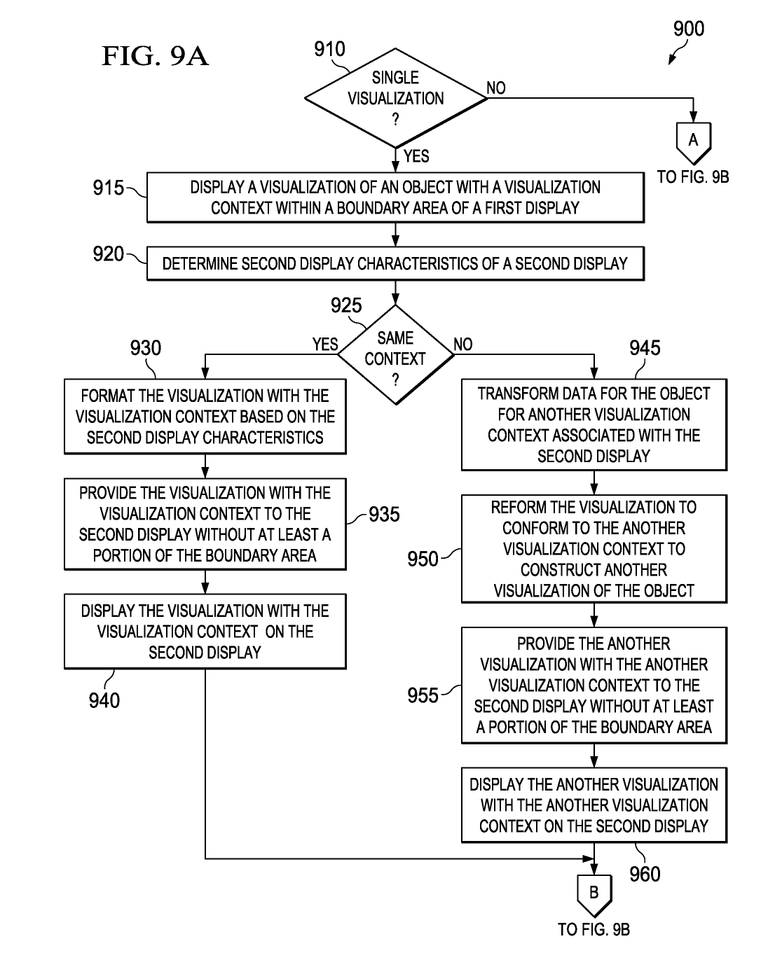

FIGS. 9A and 9B are collectively a flow-chart diagram of at least a portion of a method (900) of operating a system according to one or more aspects of the present disclosure. The method (900) includes determining (910) if there is a single visualization of an object for display. If there is a single visualization, a visualization of an object with a visualization context is displayed (915) within a boundary area of a first display based on first display characteristics thereof. Second display characteristics of a second display are then determined (920). The first display characteristics and the second display characteristics may include operational modes (e.g., work mode or presentation mode) of the first display and the second display, respectively. Also, the second display may be identified with an instant messaging client associated with the first display. The first display may be associated with a first electronic device having a first operating system, and the second display may be associated with a second electronic device having a second operating system.

The method (900) also includes determining (925) if the same visualization context of the object is employed for the first and second displays. If the same visualization context is employed, the visualization with the visualization context is formatted (930) based on the second display characteristics. The visualization with the visualization context is then provided (935) to the second display without at least a portion of the boundary area for display thereon. The visualization with the visualization context is then displayed (940) on the second display. If, however, it is determined (925) that different visualization contexts are employed, data for the object is transformed (945) for another visualization context associated with the second display. The visualization is then reformed (950) to conform to the other visualization context to construct another visualization of the object. The other visualization with the other visualization context is then provided (955) to the second display without at least a portion of the boundary area for display thereon. The other visualization with the other visualization context is then displayed (960) on the second display.

If it is determined (910) that there are a plurality of visualizations of the object, the system displays (965) the plurality of visualizations in a first visualization layout within the boundary area of the first display based on the first display characteristics. Second display characteristics of the second display are then determined (967). The method (900) may then include determining (970) if the first display and the second display should employ the same visualizations layout based at least in part on the first display characteristics and the second display characteristics, respectively. If the second display can employ the same visualization layout as the first display, the plurality of visualizations in the first visualization layout are formatted (972) based on the second display characteristics. The plurality of visualizations in the first visualization layout are then provided (974) to the second display without at least a portion of the boundary area for display thereon. The plurality of visualizations in the first visualization layout are then displayed (976) on the second display.

If it is determined (970) that the second display should employ a different visualization layout than the first display, the plurality of visualizations in a second visualization layout are formatted (978) based on the second display characteristics. The plurality of visualizations in the second visualization layout are then provided (980) to the second display without at least a portion of the boundary area for display thereon. The plurality of visualizations in the second visualization layout are then displayed (982) on the second display.

The method (900) may then include determining (984) if a boundary area associated with the first display or the second display (if a boundary area is present on the second display) should be modified. If the boundary area of the first display and/or the second display should be modified, then the system modifies (986) the boundary area (e.g., removing a toolbar) of the first display and/or the second display.

The method (900) may then include determining (988) if data for the object should be updated. If the data for the object should be updated, the system updates (990) the data (e.g., in accordance with an input tree) for the object to produce an updated visualization, an updated other visualization, or an updated plurality of visualizations in the first or second visualization layouts. Thereafter, or if the data for the object won't be updated, various additional operations may be performed (995).

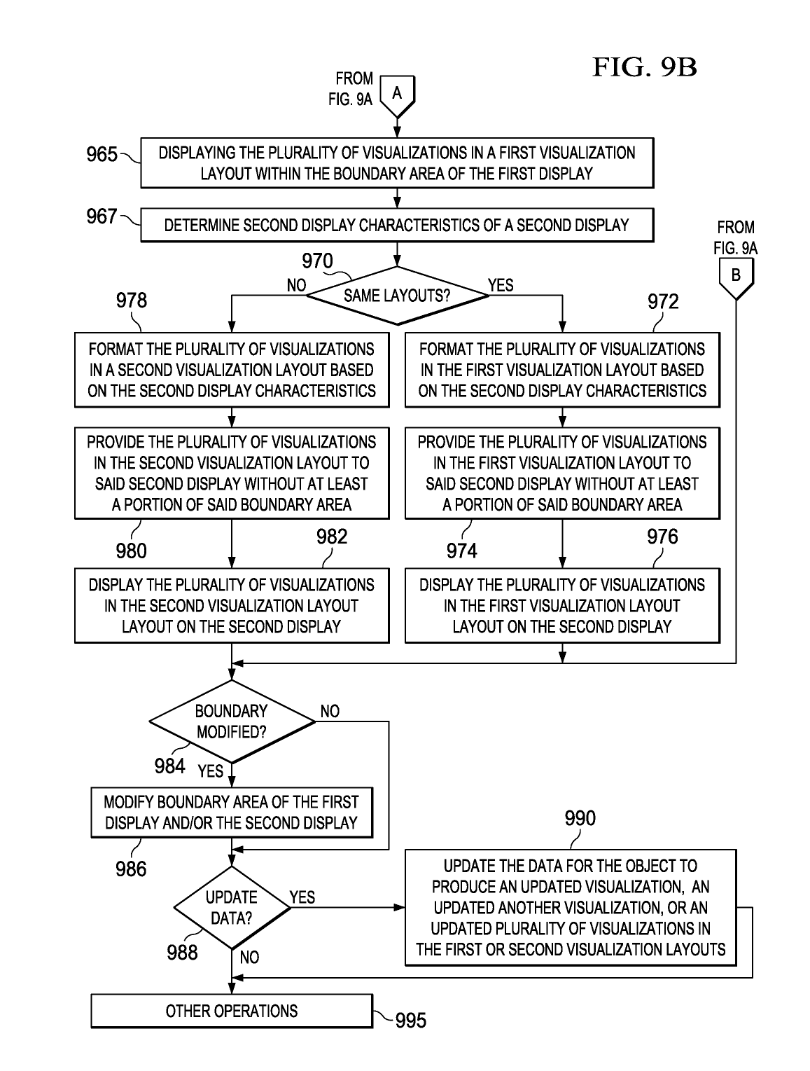

FIG. 10 is a block diagram of at least a portion of an electronic device (e.g., a computer) 1000 according to one or more aspects of the present disclosure. The electronic device 1000 may include one or more processors 1010 of varying core configurations (including multiple cores) and clock frequencies. The one or more processors 1010 may be operable to execute instructions, apply logic, etc. It will be appreciated that these functions may be provided by multiple processors or multiple cores on a single chip operating in parallel and/or communicably linked together.

The electronic device 1000 may also include a memory system (or memory), which may be or include one or more memory devices and/or computer readable medium 1020 of varying physical dimensions, accessibility, storage capacities, etc., such as an electronic circuit, a semiconductor memory device, a read only memory (“ROM”), a flash memory, an erasable ROM (“EROM”), a floppy diskette, a compact disk (“CD”)-ROM, an optical disk, a hard disk, etc., for storing data, such as images, files, and program instructions or computer program code for execution by the processor 1010. The one or more memory devices and/or computer readable medium 1020 may store instructions that, when executed by the processor 1010, are operable to cause the electronic device 1000 to perform operations. For example, execution of such instructions may cause the electronic device 1000 to implement one or more portions and/or implementations of method described above and/or otherwise within the scope of the present disclosure.

The electronic device 1000 may also include one or more network interfaces 1030. The network interfaces 1030 may include hardware, applications, and/or other software. Accordingly, the network interfaces 1030 may include Ethernet adapters, wireless transceivers, PCI interfaces, and/or serial network components, for communicating over wired or wireless media using protocols, such as Ethernet, wireless Ethernet, and/or others.

The electronic device 1000 may further include one or more peripheral interfaces 1040 for communication with one or more displays, projectors, keyboards, mice, touchpads, sensors, and/or other types of input and/or output peripherals. The components of the electronic device 1000 may not be enclosed within a single enclosure or even located in close proximity to one another. However, the components of the electronic device 1000 and/or others may be provided in a single enclosure.

The one or more memory devices and/or computer readable medium 1020 may be physically and/or logically arranged and/or otherwise operable to store data on one or more storage devices 1050. The storage device(s) 1050 may include one or more file systems or databases in various formats. The storage device(s) 1050 may also include one or more software programs 1060, which may contain interpretable or executable instructions or computer program code for performing one or more of the processes disclosed herein. When requested by the processor 1010, one or more of the software programs 1060, or a portion thereof, may be loaded from the storage devices 1050 to the memory devices and/or computer readable medium 1020 for execution by the processor 1010. The one or more of the software programs 1060 may include an operating system to control the overall operation of the electronic device 1000.

Thus, a system and/or other apparatus according to one or more aspects of the present disclosure may be embodied in an electronic device including a processor and memory including computer program code, operable to display a first visualization of an object with a first visualization context in a first display area (e.g., on a first display), and select the first visualization in response to a stimulus. The stimulus may include moving the first visualization to a second display area (e.g., on a second display) or moving the first visualization to an icon associated with a second visualization context. The second display may be identified with an instant messaging client associated with the first display. If the system is associated with geoscience system, the first visualization context and the second visualization context may be a 2-D or 3-D contour map of the object (e.g., a well), a histogram graph of the object, a temperature map of the object, and a pressure map of the object.

The processor and memory including computer program code may also be operable to transform data for the object for the second visualization context associated with the second display area, and reform the first visualization to conform to the second visualization context to construct the second visualization of the object for display in the second display area. If more data is called for to create the second visualization of the object with the second visualization context, the processor and memory including computer program code may be further operable to obtain the additional data to create the second visualization of the object. The system may obtain the data by fetching data from an input tree and/or fetching data from a public data source to construct the second visualization of the object. The processor and memory including computer program code may be further operable to display the second visualization in the second display area.

In the event that a boundary area associated with the first display or the second display should be modified, the processor and memory including computer program code may be further operable to modify the boundary area (such as by removing a toolbar) of the first display and/or the second display to, for instance, increase the display area thereof. Also, if data for the object should be updated, the processor and memory including computer program code may be further operable to update the data (e.g., in accordance with an input tree) for the object to produce an updated first visualization and an updated second visualization.

A system according to one or more aspects of the present disclosure may be embodied in an electronic device and be operable with an object with a visualization for display. The electronic device may include a processor and memory including computer program code operable to display the visualization of the object with a visualization context within a boundary area of a first display (e.g., operable with a first electronic device having a first operating system) based on first display characteristics thereof, and determine second display characteristics of a second display (e.g., operable with a second electronic device having a second operating system). The first display characteristics and the second display characteristics may include operational modes (e.g., work mode or presentation mode) of the first display and the second display, respectively. Also, the second display may be identified with an instant messaging client associated with the first display.

If the same visualization context of the object is employed for the first and second displays, the processor and memory including computer program code may be operable to format the visualization with the visualization context based on the second display characteristics, provide the visualization with the visualization context to the second display without at least a portion of the boundary area, and display the visualization with the visualization context on the second display. If different visualization contexts are employed, the processor and memory including computer program code may be operable to transform data for the object for another visualization context associated with the second display, conform the visualization to conform to the another visualization context to construct another visualization of the object, provide the another visualization with the another visualization context to the second display without at least a portion of the boundary area, and display the another visualization with the another visualization context on the second display.

If a boundary area associated with the first display or the second display (if a boundary area is present on the second display) should be modified, the processor and memory including computer program code may be operable to modify the boundary area (e.g., removing a toolbar) of the first display and/or the second display. If the data for the object should be updated, the processor and memory including computer program code may be operable to update the data (e.g., in accordance with an input tree) for the object to produce an updated visualization or an updated another visualization.

A system according to one or more aspects of the present disclosure may be embodied in an electronic device and be operable with an object with a plurality of visualizations for display. The electronic device may include a processor and memory including computer program code operable to display the plurality of visualizations in a first visualization layout within the boundary area of the first display (e.g., operable with a first electronic device having a first operating system) based on the first display characteristics, and determine second display characteristics of the second display (e.g., operable with a second electronic device having a second operating system).

If the first display and the second display employ the same visualizations layout based at least in part on the first display characteristics and the second display characteristics, respectively, the processor and memory including computer program code may be operable to format the plurality of visualizations in the first visualization layout based on the second display characteristics, provide the plurality of visualizations in the first visualization layout to the second display without at least a portion of the boundary area, and display the plurality of visualizations in the first visualization layout on the second display. If the second display employs a different visualization layout than the first display, the processor and memory including computer program code may be operable to format the plurality of visualizations in a second visualization layout based on the second display characteristics, provide the plurality of visualizations in the second visualization layout to the second display without at least a portion of the boundary area, and display the plurality of visualizations in the second visualization layout on the second display.

If a boundary area associated with the first display or the second display (if a boundary area is present on the second display) should be modified, the processor and memory including computer program code may be operable to modify the boundary area (e.g., removing a toolbar) of the first display and/or the second display. If the data for the object should be updated, the processor and memory including computer program code may be operable to update the data (e.g., in accordance with an input tree) for the object to produce an updated plurality of visualizations in the first or second visualization layouts.

A person having ordinary skill in the art will appreciate that the above-described componentry embodies merely one implementation of a hardware configuration, as the electronic device 1000 may include various types of hardware components, including the accompanying firmware or software, for performing one or more aspects of the present disclosure. The electronic device 1000 may also be implemented in part or in whole by electronic circuit components or processors, such as application-specific integrated circuits (ASICs) or field-programmable gate arrays (FPGAs).

Thus, program or code segments making up the various implementations of the present disclosure may be stored in a computer readable medium or transmitted by a computer data signal. For instance, a computer program product including a program code stored in a computer readable medium (e.g., a non-transitory computer readable medium) may form various implementations within the scope of the present disclosure. The “computer readable medium” may be or comprise a medium that can store or transfer information.

One or more techniques described herein with reference to a computer may also or instead be utilized to execute programs according to instructions received from another program or from another processor system altogether. Similarly, commands may be received, executed, and their output returned entirely within the processing and/or memory of a computer within the scope of the present disclosure. Accordingly, a visual interface command terminal, another terminal, or no terminal may be utilized according to one or more aspects of the present disclosure.

Likewise, the actions described above may be performed in different sequences relative to those discussed, and with or without the same degree of separation. Various actions described herein may be omitted, repeated, combined, or divided, and yet remain within the scope of the present disclosure. In addition, unless specified otherwise, the term “execute” and its variants in the above description and in the below claims are to be interpreted as pertaining to an operation of program code or instructions on a device, whether compiled, interpreted, or run using other techniques.

In view of the entirety of the present disclosure, including the figures, a person having ordinary skill in the art should readily recognize that the present disclosure introduces a method comprising: displaying a first visualization of an object with a first visualization context in a first display area; selecting the first visualization in response to a stimulus; transforming data for the object for a second visualization context associated with a second display area; and reforming the first visualization to conform to the second visualization context to construct a second visualization of the object for display in the second display area. The method may further comprise displaying the second visualization in the second display area. The transforming may further comprise fetching data from an input tree to transform data for the object for the second visualization context. The transforming may further comprise fetching data from a public data source to transform data for the object for the second visualization context.

The method may further comprise modifying a boundary area of a display associated with at least one of the first display area and the second display area. The modifying may further comprise removing a toolbar of the boundary area to produce an increased display area.

The selecting may further comprise moving the first visualization to the second display area.

The selecting may further comprise moving the first visualization to an icon associated with the second visualization context.

The method may further comprise updating data for the object to produce an updated first visualization and an updated second visualization. The updating may further comprise updating data for the object in an input tree.

The first display area may be on a first display and the second display area may be on a second display. The method may further comprise identifying the second display with an instant messaging client associated with the first display.

The method may be employable with a geoscience system. At least one of the first visualization context and the second visualization context may be selected from: a 2D contour map of the object; a 3D contour map of the object; a histogram graph of the object; a temperature map of the object; and a pressure map of the object.

The present disclosure also introduces an apparatus comprising: a processor; and memory including computer program code; wherein the processor, the memory, and the computer program code are collectively operable to cause the apparatus to: display a first visualization of an object with a first visualization context in a first display area; select the first visualization in response to a stimulus; transform data for the object for a second visualization context associated with a second display area; and reform the first visualization to conform to the second visualization context to construct a second visualization of the object for display in the second display area. The processor, the memory, and the computer program code may collectively be further operable to cause the apparatus to display the second visualization in the second display area. The processor, the memory, and the computer program code may collectively be further operable to cause the apparatus to fetch data from an input tree to transform data for the object for the second visualization context. The processor, the memory, and the computer program code may collectively be further operable to cause the apparatus to fetch data from a public data source to transform data for the object for the second visualization context.

The processor, the memory, and the computer program code may collectively be further operable to cause the apparatus to modify a boundary area of a display associated with at least one of the first display area and the second display area. The processor, the memory, and the computer program code may collectively be further operable to cause the apparatus to modify the boundary area of the display by removing a toolbar of the boundary area to produce an increased display area.

The processor, the memory, and the computer program code may collectively be further operable to cause the apparatus to select the first visualization by moving the first visualization to the second display area.

The processor, the memory, and the computer program code may collectively be further operable to cause the apparatus to select the first visualization by moving the first visualization to an icon associated with the second visualization context.

The processor, the memory, and the computer program code may collectively be further operable to cause the apparatus to update data for the object to produce an updated first visualization and an updated second visualization. The processor, the memory, and the computer program code may collectively be further operable to cause the apparatus to update data for the object in an input tree to produce the updated first visualization and the updated second visualization.

The first display area may be on a first display and the second display area may be on a second display. The processor, the memory, and the computer program code may collectively be further operable to cause the apparatus to identify the second display with an instant messaging client associated with the first display.

The apparatus may be employable with a geoscience system and at least one of the first visualization context and the second visualization context may be selected from: a 2D contour map of the object; a 3D contour map of the object; a histogram graph of the object; a temperature map of the object; and a pressure map of the object.

The present disclosure also introduces a computer program product comprising a program code stored in a tangible form in a computer readable medium, operable to cause an apparatus comprising a processor and a memory to: display a first visualization of an object with a first visualization context in a first display area; select the first visualization in response to a stimulus; transform data for the object for a second visualization context associated with a second display area; and reform the first visualization to conform to the second visualization context to construct a second visualization of the object for display in the second display area.

The program code stored in the computer readable medium may be operable to cause the apparatus to display the second visualization in the second display area.

The program code stored in the computer readable medium may be operable to cause the apparatus to fetch data from an input tree or from a public data source to transform data for the object for the second visualization context.

The program code stored in the computer readable medium may be operable to cause the apparatus to modify a boundary area of a display associated with at least one of the first display area and the second display area.

The program code stored in the computer readable medium may be operable to cause the apparatus to select the first visualization by moving the first visualization to the second display area or moving the first visualization to an icon associated with the second visualization context.

The program code stored in the computer readable medium may be operable to cause the apparatus to update data for the object to produce an updated first visualization and an updated second visualization.

The first display area may be on a first display and the second display area may be on a second display. The program code stored in the computer readable medium may be operable to cause the apparatus to identify the second display with an instant messaging client associated with the first display.

The computer program product may be employable with a geoscience system and at least one of the first visualization context and the second visualization context may be selected from: a 2D contour map of the object; a 3D contour map of the object; a histogram graph of the object; a temperature map of the object; and a pressure map of the object.

The present disclosure also introduces a method comprising: displaying a visualization of an object within a boundary area of a first display based on first display characteristics thereof; determining second display characteristics of a second display; formatting the visualization based on the second display characteristics; providing the visualization to the second display without at least a portion of the boundary area for display thereon.

The method may further comprise displaying the visualization on the second display.

The visualization may be part of a plurality of visualizations of the object, and the method may further comprise: displaying the plurality of visualizations in a visualization layout within the boundary area of the first display based on the first display characteristics; formatting the plurality of visualizations in the visualization layout based on the second display characteristics; and providing the plurality of visualizations in the visualization layout to the second display without at least a portion of the boundary area for display thereon. The method may further comprise displaying the plurality of visualizations in the visualization layout on the second display.

The visualization may be part of a plurality of visualizations of the object, and the method may further comprise: displaying the plurality of visualizations in a first visualization layout within the boundary area of the first display based on the first display characteristics; formatting the plurality of visualizations in a second visualization layout based on the second display characteristics; and providing the plurality of visualizations in the second visualization layout to the second display without at least a portion of the boundary area for display thereon. The method may further comprise displaying the plurality of visualizations in the second visualization layout on the second display. The first visualization layout and the second visualization layout may have different configurations based on the first display characteristics and the second display characteristics, respectively.

The method may further comprising: displaying the visualization with a visualization context within the boundary area of the first display based on first display characteristics; transforming data for the object for another visualization context associated with the second display; reforming the visualization to conform to the another visualization context to construct another visualization of the object; and providing the another visualization to the second display without at least a portion of the boundary area for display thereon. The method may further comprise displaying the another visualization on the second display.

The first display characteristics and the second display characteristics may include operational modes of the first display and the second display, respectively.

The method may further comprise modifying the boundary area of the first display.

The method may further comprise identifying the second display with an instant messaging client associated with the first display.

The method may further comprise updating data for the object to produce an updated visualization.

The first display may be associated with a first electronic device having a first operating system and the second display may be associated with a second electronic device having a second operating system.

The present disclosure also introduces an apparatus comprising: a processor; and memory including computer program code; wherein the processor, the memory, and the computer program code are collectively operable to cause the apparatus to: display a visualization of an object within a boundary area of a first display based on first display characteristics thereof, determine second display characteristics of a second display; format the visualization based on the second display characteristics; provide the visualization to the second display without at least a portion of the boundary area for display thereon. The processor, the memory, and the computer program code may collectively be further operable to cause the apparatus to display the visualization on the second display.

The visualization may be part of a plurality of visualizations of the object and the processor, the memory, and the computer program code may collectively be further operable to cause the apparatus to: display the plurality of visualizations in a visualization layout within the boundary area of the first display based on the first display characteristics; format the plurality of visualizations in the visualization layout based on the second display characteristics; and provide the plurality of visualizations in the visualization layout to the second display without at least a portion of the boundary area for display thereon. The processor, the memory, and the computer program code may collectively be further operable to cause the apparatus to display the plurality of visualizations in the visualization layout on the second display.

The visualization may be part of a plurality of visualizations of the object and the processor, the memory, and the computer program code may collectively be further operable to cause the apparatus to: display the plurality of visualizations in a first visualization layout within the boundary area of the first display based on the first display characteristics; format the plurality of visualizations in a second visualization layout based on the second display characteristics; and provide the plurality of visualizations in the second visualization layout to the second display without at least a portion of the boundary area for display thereon. The processor, the memory, and the computer program code may collectively be further operable to cause the apparatus to display the plurality of visualizations in the second visualization layout on the second display. The first visualization layout and the second visualization layout may have different configurations based on the first display characteristics and the second display characteristics, respectively.

The processor, the memory, and the computer program code may collectively be further operable to cause the apparatus to: display the visualization with a visualization context within the boundary area of the first display based on first display characteristics; transform data for the object for another visualization context associated with the second display; reform the visualization to conform to the another visualization context to construct another visualization of the object; and provide the another visualization to the second display without at least a portion of the boundary area for display thereon. The processor, the memory, and the computer program code may collectively be further operable to cause the apparatus to display the another visualization on the second display.

The first display characteristics and the second display characteristics may include operational modes of the first display and the second display, respectively.

The processor, the memory, and the computer program code may collectively be further operable to cause the apparatus to modify the boundary area of the first display.

The processor, the memory, and the computer program code may collectively be further operable to cause the apparatus to identify the second display with an instant messaging client associated with the first display.

The processor, the memory, and the computer program code may collectively be further operable to cause the apparatus to update data for the object to produce an updated visualization.

The first display may be associated with a first electronic device having a first operating system and the second display may be associated with a second electronic device having a second operating system.

The present disclosure also introduces a computer program product comprising a program code stored in a tangible form in a computer readable medium, operable to cause an apparatus comprising a processor and a memory to: display a visualization of an object within a boundary area of a first display based on first display characteristics thereof; determine second display characteristics of a second display; format the visualization based on the second display characteristics; provide the visualization to the second display without at least a portion of the boundary area for display thereon.

The visualization may be part of a plurality of visualizations of the object and the program code stored in the computer readable medium may be operable to cause the apparatus to: display the plurality of visualizations in a visualization layout within the boundary area of the first display based on the first display characteristics; format the plurality of visualizations in the visualization layout based on the second display characteristics; and provide the plurality of visualizations in the visualization layout to the second display without at least a portion of the boundary area for display thereon.

The visualization may be part of a plurality of visualizations of the object and the program code stored in the computer readable medium may be operable to cause the apparatus to: display the plurality of visualizations in a first visualization layout within the boundary area of the first display based on the first display characteristics; format the plurality of visualizations in a second visualization layout based on the second display characteristics; and provide the plurality of visualizations in the second visualization layout to the second display without at least a portion of the boundary area for display thereon.

The program code stored in the computer readable medium may be operable to cause the apparatus to: display the visualization with a visualization context within the boundary area of the first display based on first display characteristics; transform data for the object for another visualization context associated with the second display; reform the visualization to conform to the another visualization context to construct another visualization of the object; and provide the another visualization to the second display without at least a portion of the boundary area for display thereon.

The program code stored in the computer readable medium may be operable to cause the apparatus to modify the boundary area of the first display.

The program code stored in the computer readable medium may be operable to cause the apparatus to update data for the object to produce an updated visualization.

The first display may be associated with a first electronic device having a first operating system and the second display may be associated with a second electronic device having a second operating system.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same purposes and/or achieving the same advantages of the embodiments introduced herein. A person having ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

What is claimed is:

1. A method, comprising:
displaying a visualization of an object within a boundary area of a first display based on first display characteristics thereof;
determining second display characteristics of a second display;
formatting the visualization based on the second display characteristics; and
providing the visualization to the second display without at least a portion of the boundary area for display thereon.

2. The method of claim 1 further comprising displaying the visualization on the second display.

3. The method of claim 1 wherein the visualization is part of a plurality of visualizations of the object, and the method further comprises:
displaying the plurality of visualizations in a visualization layout within the boundary area of the first display based on the first display characteristics;
formatting the plurality of visualizations in the visualization layout based on the second display characteristics; and
providing the plurality of visualizations in the visualization layout to the second display without at least a portion of the boundary area for display thereon.

4. The method of claim 3 further comprising displaying the plurality of visualizations in the visualization layout on the second display.

5. The method of claim 1 wherein the visualization is part of a plurality of visualizations of the object, and the method further comprises:
displaying the plurality of visualizations in a first visualization layout within the boundary area of the first display based on the first display characteristics;
formatting the plurality of visualizations in a second visualization layout based on the second display characteristics; and
providing the plurality of visualizations in the second visualization layout to the second display without at least a portion of the boundary area for display thereon.

6. The method of claim 5 wherein the first visualization layout and the second visualization layout have different configurations based on the first display characteristics and the second display characteristics, respectively.

7. The method of claim 1 further comprising:
displaying the visualization with a visualization context within the boundary area of the first display based on first display characteristics;
transforming data for the object for another visualization context associated with the second display;
reforming the visualization to conform to the another visualization context to construct another visualization of the object; and
providing the another visualization to the second display without at least a portion of the boundary area for display thereon.

8. The method of claim 1 wherein the first display characteristics and the second display characteristics include operational modes of the first display and the second display, respectively.

9. The method of claim 1 further comprising modifying the boundary area of the first display.

10. The method of claim 1 further comprising identifying the second display with an instant messaging client associated with the first display.

11. The method of claim 1 further comprising updating data for the object to produce an updated visualization.

12. The method of claim 1 wherein the first display is associated with a first electronic device having a first operating system and the second display is associated with a second electronic device having a second operating system.

13. An apparatus, comprising:
a processor, and
memory including computer program code;
wherein the processor, the memory, and the computer program code are collectively operable to cause the apparatus to:
display a visualization of an object within a boundary area of a first display based on first display characteristics thereof;
determine second display characteristics of a second display;
format the visualization based on the second display characteristics; and
provide the visualization to the second display without at least a portion of the boundary area for display thereon.

14. The apparatus of claim 13 wherein the processor, the memory, and the computer program code are collectively further operable to cause the apparatus to display the visualization on the second display.

15. The apparatus of claim 13 wherein the first display characteristics and the second display characteristics include operational modes of the first display and the second display, respectively.

16. The apparatus of claim 13 wherein the processor, the memory, and the computer program code are collectively further operable to cause the apparatus to identify the second display with an instant messaging client associated with the first display.

17. The apparatus of claim 13 wherein the first display is associated with a first electronic device having a first operating system and the second display is associated with a second electronic device having a second operating system.

18. A computer program product comprising a program code stored in a tangible form in a computer readable medium, operable to cause an apparatus comprising a processor and a memory to:
display a visualization of an object within a boundary area of a first display based on first display characteristics thereof;
determine second display characteristics of a second display;
format the visualization based on the second display characteristics; and
provide the visualization to the second display without at least a portion of the boundary area for display thereon.

19. The apparatus of claim 18 wherein the program code stored in the computer readable medium is operable to cause the apparatus to:
display the visualization with a visualization context within the boundary area of the first display based on first display characteristics;
transform data for the object for another visualization context associated with the second display;
reform the visualization to conform to the another visualization context to construct another visualization of the object; and
provide the another visualization to the second display without at least a portion of the boundary area for display thereon.

20. The apparatus of claim 18 wherein the program code stored in the computer readable medium is operable to cause the apparatus to:
modify the boundary area of the first display, and
update data for the object to produce an updated visualization.
